(19) United States
(12) Patent Application Publication
(10) Pub. No.: US 2014/0030982 A1
(43) Pub. Date: Jan. 30, 2014

(54) METHOD AND APPARATUS FOR DISTANCE ESTIMATE USING SIGNAL STRENGTH INFORMATION

(71) Applicant: Javier Cardona, San Francisco, CA (US)

(72) Inventor: Javier Cardona, San Francisco, CA (US)

(21) Appl. No.: 13/924,238

(22) Filed: Jun. 21, 2013

Related U.S. Application Data
(60) Provisional application No. 61/670,545, filed on Jul. 11, 2012.

(51) Int. Cl. G01S 11/06

(52) U.S. Cl. CPC G01S 11/06
USPC 455/67.11

(57) ABSTRACT

A method and apparatus are disclosed herein for distance estimation using signal strength information. In one embodiment, the method comprises receiving a broadcast communication from one of a plurality of devices in a wireless mesh network in which devices communicate via peer-to-peer communication, measuring signal strength information corresponding to the received broadcast communication, and using the signal strength information to determine an estimate of distance between a first device and the one device.

### PRIORITY

The present patent application claims priority to and incorporates by reference the corresponding provisional patent application Ser. No. 61/670,545, titled, “Range Threshold via Peer to Peer Wireless,” filed on Jul. 11, 2012.

### FIELD OF THE INVENTION

Embodiments of the present invention relate to the field of wireless mesh networks; more particularly, embodiments of the present invention relate to estimating the distance between devices in a wireless mesh network using signal strength information.

### BACKGROUND OF THE INVENTION

As the electronic devices in our lives and homes gain the ability to communicate wirelessly and the computing power to sense and make decisions about how to interact with us, new methods of informing and controlling those interactions become possible.

Recently, 802.11s wireless mesh networks have been implemented and used for communication. In a 802.11s mesh network, every peer device sends beacons that are received by all other peers that are within the communication range of the peer. According to Std. IEEE 802.11-2012, Section 4.3.15.5.5, the purpose of mesh beaconing is to “assist mesh discovery, mesh power management and synchronization in “mesh BSS”.

The use of beacons in 802.11s wireless mesh networks is different from infrastructure 802.11 networks or even Wi-Fi direct peer-to-peer networks as these networks form a star topology and beacons are only sent by one device.

### SUMMARY OF THE INVENTION

A method and apparatus are disclosed herein for distance estimation using signal strength information. In one embodiment, the method comprises receiving a broadcast communication from one of a plurality of devices in a wireless mesh network in which devices communicate via peer-to-peer communication, measuring signal strength information corresponding to the received broadcast communication, and using the signal strength information to determine an estimate of distance between a first device and the one device.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates one embodiment of a mesh network.

FIGS. 2A-2C illustrate a process for setting the range threshold between two devices in a wireless mesh network.

FIG. 3 is a flow diagram of one embodiment of a process for monitoring a device in a wireless mesh network.

FIG. 4 is a flow diagram of an alternative embodiment of a process for monitoring a device in a wireless mesh network.

FIG. 5 illustrates devices in one embodiment of a 802.11s wireless mesh network.

FIG. 6 is a flow diagram of one embodiment of another process for performing range thresholding in a peer to peer wireless network.

FIG. 7 illustrates one embodiment of a software stack.

FIG. 8 is a flow diagram of a process to maintain and check signal strength values.

FIGS. 9A-9C illustrate a more detailed example in which device interaction could be chosen based on proximity.

FIG. 10 is a block diagram of one embodiment of a mobile device.

### DETAILED DESCRIPTION OF THE PRESENT INVENTION

A method and apparatus for estimating the distance between devices in a wireless mesh network using signal strength information are described. In one embodiment, a first device in the wireless mesh network receives a broadcast communication (e.g., a UDP frame, beacon) from another peer device in the wireless mesh network. In response thereto, the first device measures the signal strength information corresponding to the received broadcast communication and uses the signal strength information to determine an estimate of the distance between the first device and the other peer device that transmitted the broadcast communication.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview

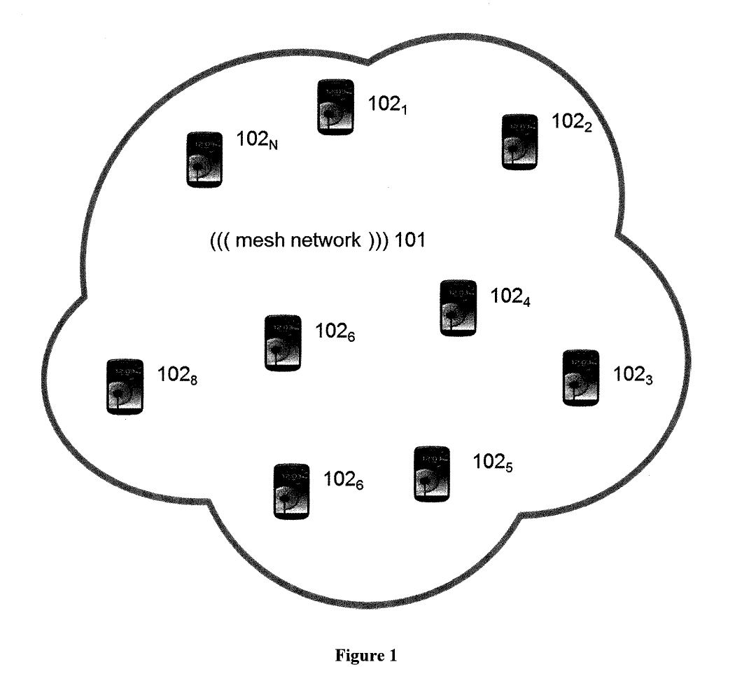

A wireless mesh network having multiple mobile devices (e.g., mobile phones, tablets, etc.) that communicate with each other is described. FIG. 1 illustrates one embodiment of a mesh network 101 with mobile devices 102_{1-N}. Referring to FIG. 1, mobile devices 102_{1-N} communicate with each other when they are within each other's vicinity using mesh network 101. Note that all the devices in the wireless mesh network do not have to be mobile devices. The wireless mesh network may include one, more or all devices that have fixed locations. Even so, for the purposes of the discussion below, it would be apparent to those skilled in the features discussed are equally applicable to fixed location devices as well.

In one embodiment, the mobile devices 102_{1-N} join the mesh network by sending announcement messages that announce or advertise their presence and their distributable content (e.g., movies, music, games, media, etc.). Each mobile device discovers other mobile devices in mobile devices 102_{1-N} that are within their vicinity (e.g., within a predetermined distance, within range of the announcement messages, etc.). In one embodiment, each of the devices represents a node in the mesh network and has a unique ID derived from the MAC address of its wireless interface. Therefore, there is a unique ID associated with every one of those nodes. This unique ID facilitates the mobile device being recognized as a previous member of the mesh network in case the mobile device leaves and then rejoins the network.

In one embodiment, the mesh network software used by each of the mobile devices 102_{1-N} is open 80211s, the open mesh stack that is part of the Linux kernel version 3.8.

In one embodiment, the wireless mesh network uses a path selection protocol when a mobile device wants to communicate with another mobile device in the wireless mesh network. In this case, the mobile device sends a broadcast message that queries how to reach that other mobile device. In one embodiment, the path selection protocol computes a metric and creates a topology that can be used to determine a route for the communication when it needs to do so. Any message will then be forward along that determined route. In one embodiment, if the message is being sent through multiple mobile devices to reach its destination, then the message contains information indicating to the mobile devices that receive it that they need to forward the message onward to its destination.

When a mobile device leaves the group, the other mobile devices stop receiving the announcements from that mobile device. In response to this occurring, notifications are sent to provide an indication that the mobile device is no longer available.

When any mobile devices of a group that has been split away from a mesh network are back within range, they automatically and seamlessly rejoin the group from which they split. This seamless rejoining does not require any reconnection process to occur because there was never a connection that was broken. In one embodiment, in order to reestablish communication, a messaging library is used. In one embodiment, the library is zeromq.

In one embodiment, each mobile device in mesh network 101 is operable to receive a broadcast communication (e.g., UDP frame, beacon) from another peer in the wireless mesh network, measure the signal strength information corresponding to the received broadcast communication, and use the signal strength information to determine an estimate of distance between itself and the other peer device that transmitted the broadcast communication.

In one embodiment, the broadcast communication comprises a beacon frame (e.g., a 802.11s mesh beacon). In such a case, the beacon frame is used to infer the physical proximity of one wireless mesh mobile device to another.

In one embodiment, when a mobile device in a mesh network receives a beacon from another peer, the wireless calculates a signal strength estimate. The peer collects signal strength information (e.g., RSSI) from each received beacon from each mesh peer in range and uses the information for one or more purposes. In one embodiment, a peer uses signal strength information to allow devices to present notifications or change behavior, based on distance between two or more mesh peers, as estimated by received signal strength from the mesh peer.

In one embodiment, the signal strength information is calculated by the wireless device driver of the peer. The wireless device driver collects and stores the signal strength information. The peer makes the signal strength information available to the application layer of the peer. In one embodiment, the peer makes the signal strength information available to the application layer in response to being polled by the application.

In another embodiment, the wireless network is implemented with 802.11 ad-hoc networks. In such a network, beacons are transmitted in the same manner as described herein and the RSSI associated with the received beacons can be used as a distance indication.

### Signal Strength and Range Thresholds

In one embodiment, the mobile device allows the user to set a distance threshold to be used between two mobile devices in the wireless mesh network. The distance threshold is set up to allow one mobile device to know the distance between itself and another mobile device. In one embodiment, if the two devices exceed the distance threshold, one or both of the mobile devices receives a notification indicating that the distance between the two mobile devices has exceeded its threshold.

In one embodiment, the mobile device runs an application that stores signal strength information when the user indicates that two peer mobile devices are at their maximum allowed separation. The maximum allowed separation constitutes the range threshold for the devices. The application is then able to use that signal strength information to notify the user when this distance threshold has been exceeded by the two mobile devices.

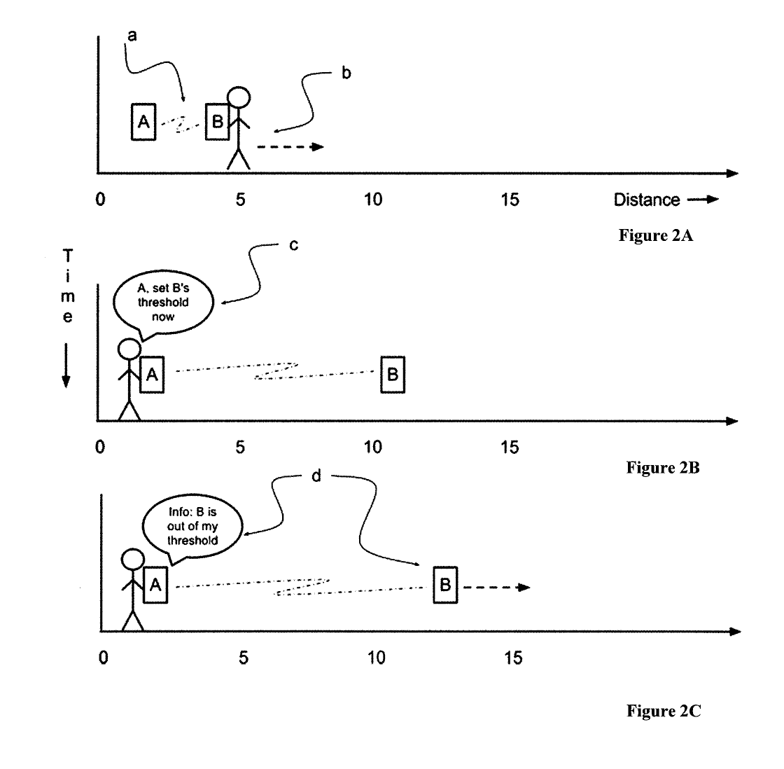

FIGS. 2A-C illustrate a process for setting the range threshold between two devices in a wireless mesh network. Referring to FIGS. 2A and 2B, two devices, A and B, are show and a range threshold is to be established to allow device A to monitor the range of device B. In one embodiment, device A presents a list of suitable peer devices to monitor, including device B. To set the range threshold, the users of devices A and B increase their physical separation until a desired physical limit is reached. At this point, the user of device A requests device A to store signal strength information associated with a communication from device B to act as a range (distance) threshold. The request may be made by selecting device B from the list on device A. Thus, the signal strength acts as an indication of the distance between devices A and B.

After storing a threshold for device B on device A, devices A and B may freely move around provided they are not separated by more than the threshold stored on device A. In one embodiment, if device A detects that the signal strength of communications (e.g., beacons) from device B are at a level below the signal strength value stored on device A, thereby indicating that device B has exceeded the stored distance threshold, device A presents a notification to device A that device B has exceeded its allowed range. This is shown in FIG. 2C. In one embodiment, such a notification comprises a message displayed on a display of device A indicating that devices A and B are separated by a distance greater than the allowed range. In other embodiments, the notification comprises an alarm sounded by device A.

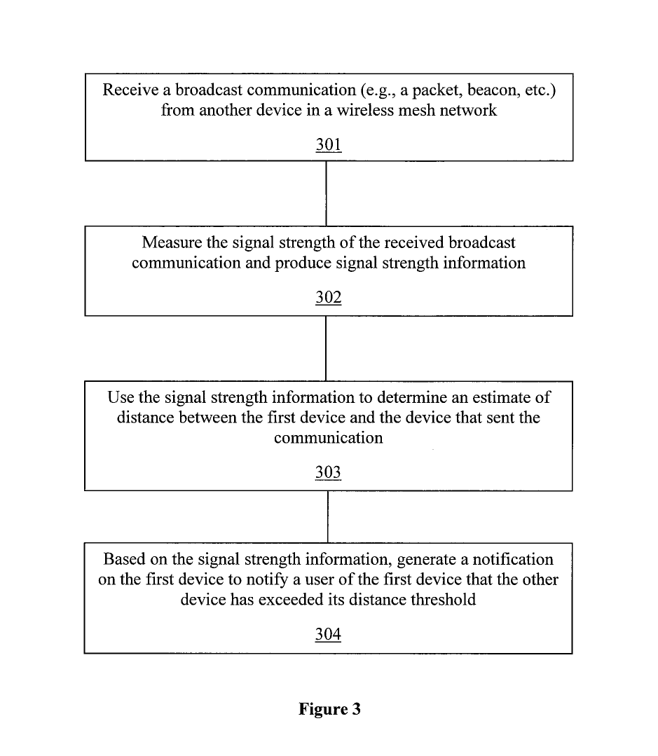

FIG. 3 is a flow diagram of one embodiment of a process for monitoring a device in a wireless mesh network. The process is performed by processing logic that may comprise hardware (circuitry, dedicated logic, etc.), software (such as is run on a general purpose computer system or a dedicated machine), or a combination of both.

Referring to FIG. 3, the process begins by processing logic of a first device receiving a broadcast communication (e.g., a packet, beacon, etc.) from a second device of a plurality of devices in a wireless mesh network (processing block 301). Processing logic measures the signal strength of the received broadcast communication and produces signal strength information (processing block 302). Processing logic uses the signal strength information to determine an estimate of distance between the first device and the second device (processing block 303). Based on the signal strength information, processing logic generates a notification on the first device to notify a user of the first device that the second device has exceeded its distance threshold (processing block 304).

In another embodiment, the distance threshold is an actual distance between devices A and B. In this case, to set the distance threshold, when devices A and B have reached the desired physical limit, device A converts the signal strength information of a communication (e.g., packet, beacon, etc.) from device B into a distance that is used as the distance threshold. In one embodiment, device A converts the signal strength information into a distance according to ranges associated with RSSI of the communication from device B as measured by device A. For example, in one embodiment, if the RSSI value is less than a predetermined value x, then the peer device being monitored is considered less than one meter away. If the RSSI value is greater than x but less than y, the peer device is presumed to be between 1 and 10 meters away. If the RSSI value is greater than y, then the peer device is assumed to be greater than 10 meters away but less than the outside range (e.g., 50 meters). Note that if a device receives tracking information from a peer device yet there is no signal strength information provided, the device assumes the peer device is greater than 50 meters away (greater than the Wi-Fi range). In such a case, where there is no RSSI information, it assumes that the peer device is receiving the other peer's information from another device in the mesh network.

Note that RSSI is available for 802.11s beacons as these are not forwarded over a mesh network. RSSI might not be available for other types of traffic (e.g., UDP broadcast messages) because those frames are forwarded over a mesh network and therefore the received signal strength (RSSI) reported for multi-hop frames is that of the last transmitting node. It is therefore safest to assume that when RSSI information is not available for the sender node of a UDP message, that sender is beyond the range of a direct link (for example, in one embodiment, roughly 50 m, but could be different).

After storing the distance threshold for device B on device A, devices A and B may freely move around provided they are not separated by more than the distance threshold stored on device A. In one embodiment, if device A detects that the signal strength of communications (e.g., beacons) from device B and converts the signal strength information into a distance and compares that distance to the distance threshold corresponding to device B that is stored in device A. If the comparison indicates devices A and B are separated by a distance greater than the distance threshold, device A presents a notification to device A to its user that device B has exceeded its allowed range. In one embodiment, such a notification comprises a message displayed on a display of device A indicating that devices A and B are separated by a distance greater than the allowed range. In other embodiments, the notification comprises an alarm sounded by device A.

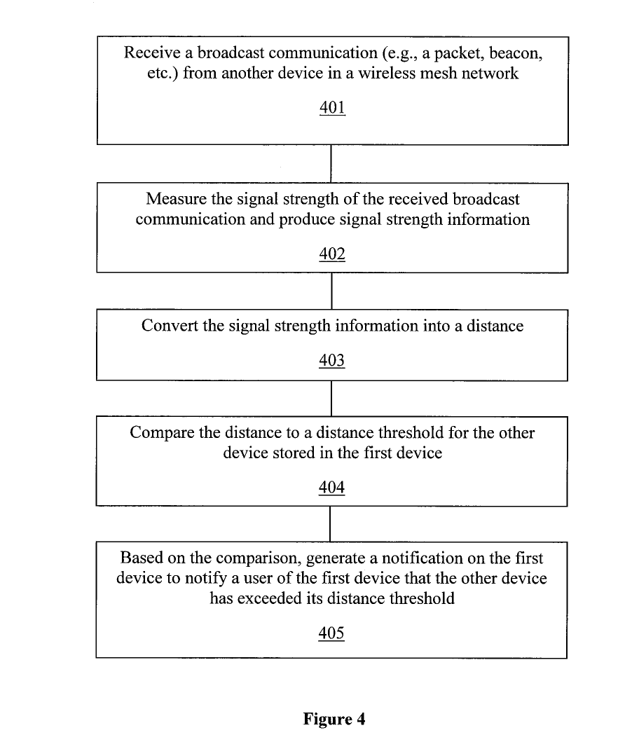

FIG. 4 is a flow diagram of an alternative embodiment of a process for monitoring a device in a wireless mesh network. The process is performed by processing logic that may comprise hardware (circuitry, dedicated logic, etc.), software (such as is run on a general purpose computer system or a dedicated machine), or a combination of both.

Referring to FIG. 4, the process begins by processing logic of a first device receiving a broadcast communication (e.g., a packet, beacon, etc.) from a second device of a plurality of devices in a wireless mesh network (processing block 401). Processing logic measures the signal strength of the received broadcast communication and produces signal strength information (processing block 402). Processing logic converts the signal strength information into a distance (processing block 403) and compares the distance to a distance threshold stored in the first device (processing block 404). Based on the comparison, processing logic generates a notification on the first device to notify a user of the first device that the second device has exceeded its distance threshold (processing block 405).

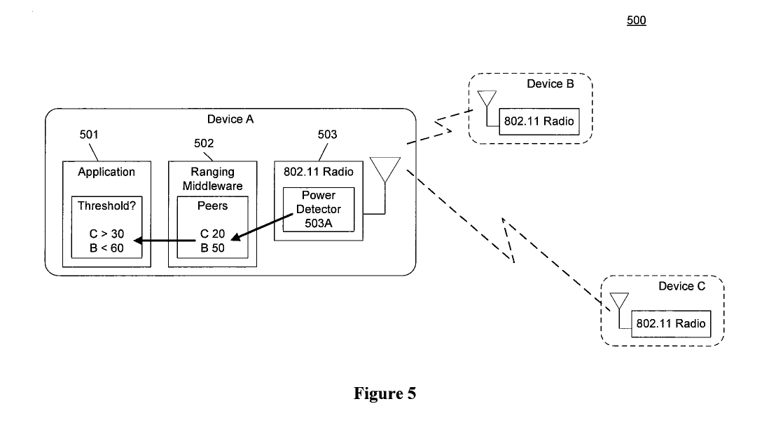

FIG. 5 illustrates devices in one embodiment of a 802.11s wireless mesh network. Referring to FIG. 5, wireless mesh network 500 includes peer devices A, B and C. Note that the wireless mesh network 500 can have more than three peer devices. However, at a minimum, wireless mesh network 500 needs two peer devices.

Each of devices A, B and C include a wireless radio and an antenna to communicate wirelessly with each other. In one embodiment, the wireless radio comprises a 802.11 radio. At least one of the devices in wireless mesh network 500 includes a power detector 503A to measure signal strength of incoming communications (e.g., packets, beacons, etc.). Device A. Device A also includes a ranging middleware 502 executing on device A to store signal strength for each peer and supply it to an application 501. Applications communicate with ranging middleware 502 by invoking the functions defined by an API. Application 501 executes on device A and stores user thresholds (e.g., distance, signal strength), checks peer signal strength against stored values, and notifies a user (e.g., via notifications) based on results of comparisons.

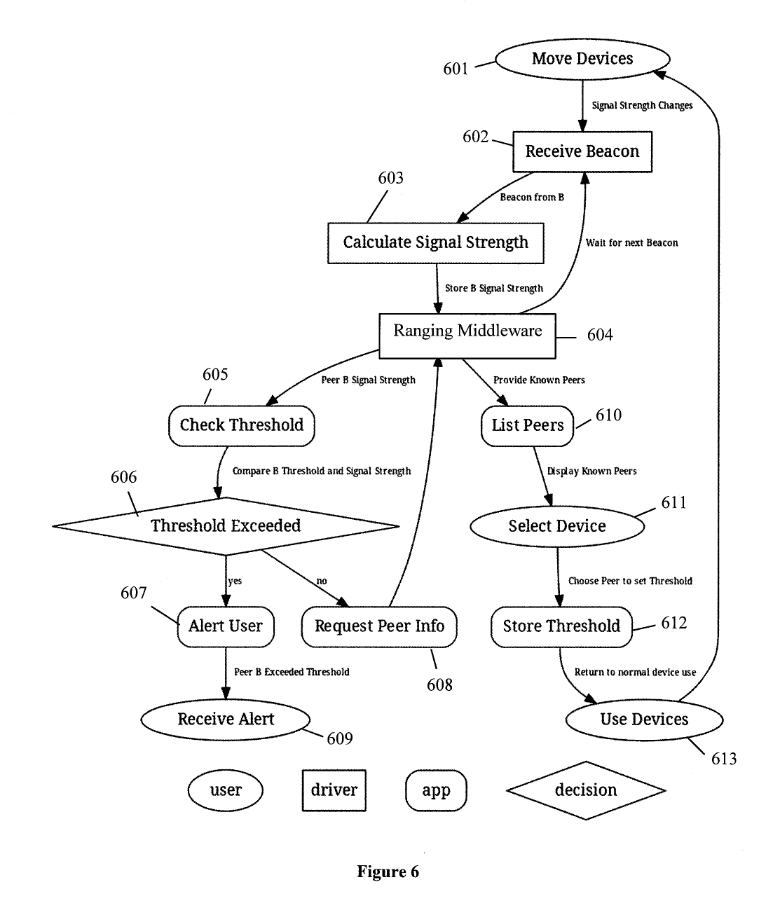

FIG. 6 is a flow diagram of one embodiment of another process for performing range thresholding in a peer to peer wireless network. The process is performed by processing logic that may comprise hardware (circuitry, dedicated logic, etc.), software (such as is run on a general purpose computer system or a dedicated machine), or a combination of both. In one embodiment, the process is performed by a device in wireless mesh network 500 of FIG. 5, such as, for example, device A.

Referring to FIG. 6, the process begins by users moving the peer devices in the mesh network (processing block 601). This causes a change in signal strength for the communications between these devices. Subsequently, one of the devices (e.g., device A of FIG. 5) receives a beacon from another peer device (e.g., device B of FIG. 5) (processing block 602). In one embodiment, the beacon is received by the driver of the peer device. Using the beacon, processing logic calculates the signal strength (processing block 603). In one embodiment, the driver of the peer device, such as device A of FIG. 5, calculates the signal strength. The signal strength is stored by the driver.

Next, processing logic runs a ranging middleware (processing block 604). In one embodiment, the driver of the peer device (e.g., device A of FIG. 5) runs the ranging middleware.

To set the threshold for a particular device, the following operations are performed. Processing logic executing the ranging middleware makes a request for the known peers to the application and the application provides lists the peer devices (processing block 610), which the ranging middleware causes to be displayed on the display of the peer device. At that point, the user selects the device to set its threshold (processing block 611). In response to the selection, the peer device stores the threshold for that user (processing block 612). Then the process transitions to processing block 601 to return the device to the normal use state for the device in which the user uses the device in the regular fashion (processing block 613).

When the peer device is checking whether the range threshold has been exceeded, the peer device performs the following operations. In one embodiment, processing logic executing the ranging middleware sends the peer signal strength calculated in processing block 603 to an application. In response to the signal strength calculated in processing block 603, processing logic of the application checks the threshold (processing block 605). Processing logic in the application checks the threshold by comparing the current signal strength to the stored threshold associated with that peer device to determine if the threshold has been exceeded (processing block 606). If not, processing logic of the application requests peer information from the ranging middleware (processing block 608) and the process transitions to processing block 604. This information allows the application to proceed to Check Threshold (processing block 605) to check if any peers had exceeded their stored threshold, which results in Alert User messages being generated. If the signal strength is less than the threshold, processing logic executing the application alerts the user, indicating that the peer has exceeded its threshold (processing block 607). The notification may include a message displayed on the display of the peer device. In an alternative embodiment, the notification may be an alarm with a tone indicative of the peer that has exceeded its threshold. Thereafter, the user receives the notification (processing block 609).

In an alternative embodiment, the logic described above is reversed to provide a notification when a device enters a perimeter (i.e., RSSI>threshold instead of RSSI<threshold). This is useful for applications such as using one phone to find another phone. For example, one user would walk around the house with one phone to trip an alarm on the lost phone when getting close to it. In another embodiment, notifications are triggered when relative RSSIs change (i.e., RSSIᵢ<RSSIⱼ), for instance to inform the user when one device is no longer the closest device and a different device has taken its place.

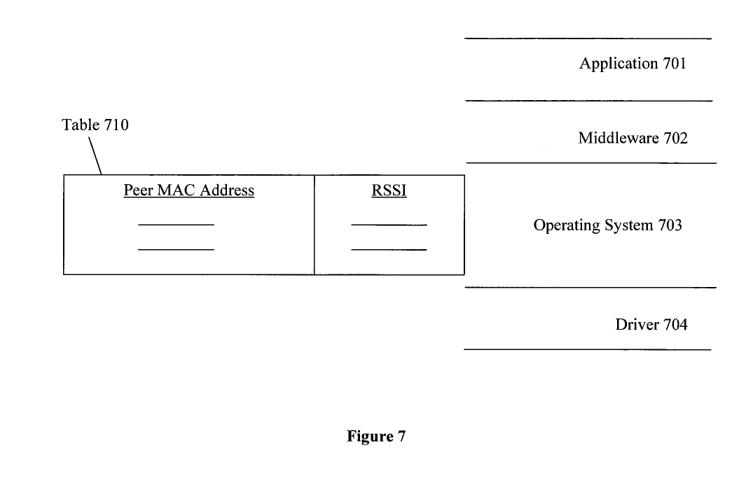

In an alternative embodiment, an alternative software stack is used. FIG. 7 illustrates one embodiment of a software stack. Referring to FIG. 7, the software stack includes application layer 701, middleware layer 702, operating system layer 703 and driver layer 704. Operating system layer 703 maintains a table 710 containing a list of the peers by MAC address along with their last signal strength value (e.g., RSSI value).

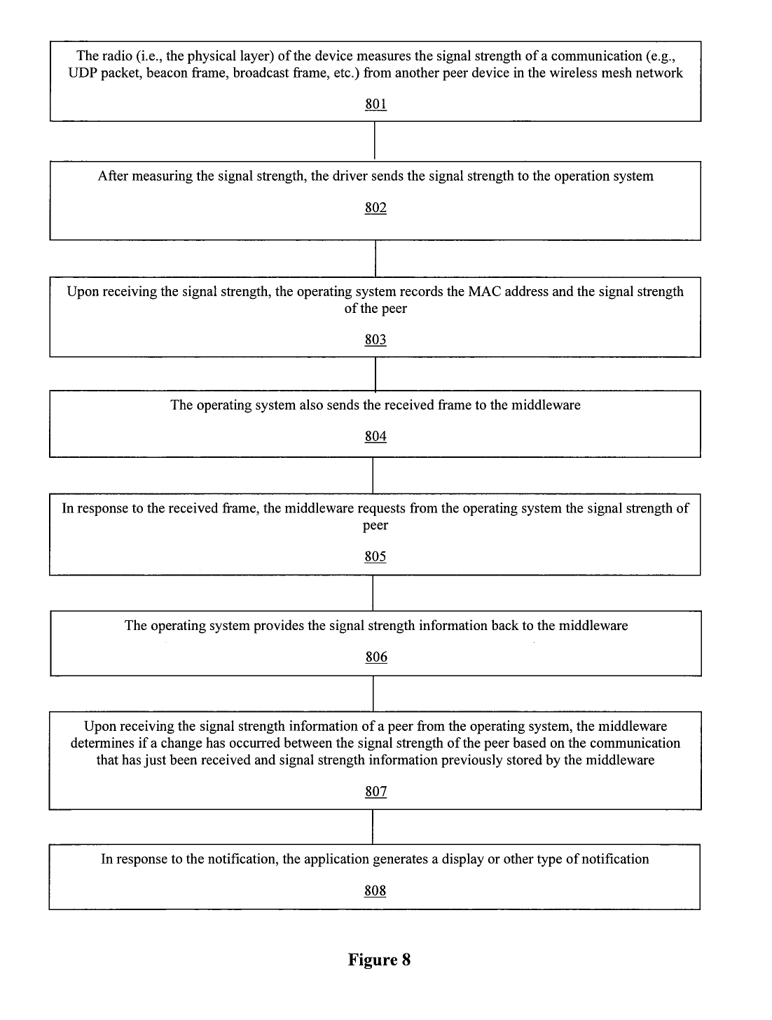

FIG. 8 is a flow diagram of a process to maintain and check signal strength values. The process is performed by processing logic that may comprise hardware (circuitry, dedicated logic, etc.), software (such as is run on a general purpose computer system or a dedicated machine), or a combination of both. In one embodiment, the process is performed by a device in a wireless mesh network.

Referring to FIG. 8, the process begins by the radio (i.e., the physical layer) of the device measuring the signal strength of a communication (e.g., UDP packet, beacon frame, broadcast frame, etc.) from another peer device in the wireless mesh network (processing block 801). The radio of the peer device includes a power detector to measure the signal strength (e.g., RSSI). After measuring the signal strength, the driver (e.g., driver layer 704) sends the signal strength to the operation system (e.g., operating system layer 703) (processing block 802). Upon receiving the signal strength, the operating system records the MAC address and the signal strength of the peer (processing block 803). In one embodiment, the operating system records the signal strength in a table (e.g., table 710). The operating system also sends the received frame to the middleware (e.g., middleware 702) (processing block 804).

In response to the received frame, the middleware requests from the operating system the signal strength of peer (processing block 805). In one embodiment, the middleware uses the MAC address to request the signal strength of the peer from the operating system. Note that in one embodiment, the middleware uses an application services lookup to identify the MAC address associated with the frame based on the IP address that is in the UDP packet. The operating system provides the signal strength information back to the middleware (processing block 806).

The middleware itself maintains a list of the peers and their signal strengths. In one embodiment, the middleware maintains an ordered list of peers that is ordered according to their signal strength.

Upon receiving the signal strength information of a peer from the operating system, the middleware determines if a change has occurred between the signal strength of the peer based on the communication that has just been received and the signal strength previously stored by the middleware (processing block 807). If a change has occurred, the middleware sends a notification to the application (e.g., application layer 701). In response to the notification, the application generates a display or other type of notification (processing block 808). The notification may indicate that a new one of the peers is the closest peer. Alternatively, the application may provide a new list of the peers sorted according to their distance from itself (e.g., closest to farthest, farthest to closest). Such may be the case when the mobile device is generating a visual directory illustrating photos of individual in proximity to a mobile device as disclosed in U.S. patent application Ser. No. 13/851,746, entitled “Method and Apparatus for Communication Between Mobile Devices.

### Additional Example Applications

### Paintball Over Mesh

The game of paintball consists of a number of players shooting at each other paint bullets. A version of the game may be implemented over mesh that works as follows.

To set up the game, a number of users are required and each with a mesh-enabled smartphone (or other wireless device) and the paintball-over-mesh application installed. Using the device, each user performs the following operations:
1. the user joins the mesh network;
2. the user launches the paintball-over-mesh application;
3. the user takes a photo of him/herself which is sent to all other players over the mesh network;
4. the user sees the photos of all the players in the game in his/her phone;
5. the user (shooter) attempts to shoot (a photo) of other players (targets) and a splash of paint is superimposed on the photo;
6. the user sends the target photo shots to other players in the mesh to confirm the shot; and
7. the shooter is awarded points if the shot is confirmed.

With the techniques disclosed herein, the shooter can determine if he/she is approaching a potential target by monitoring the signal strength of mesh beacons received from the target.

### Other Examples

Using the techniques described herein with 802.11s mesh networks, where each device has the ability to estimate the distance to each of the other devices in the network, a number of other physical proximity applications are possible.

Distance aware networks can provide a variety of arrival and departure notifications. For example, sensing the distance to a child's cell phone allows parents to know when their child has arrived or left the house, or if they truly stayed in their room during “timeout” discipline. Similarly, office managers can be informed of an employee's presence and location, and timecards could be automatically filled out based on when an employee was at their desk.

Media devices could use the same distance information to select a TV or stereo for media playback. The movie or music could be paused or ended if the user leaves the room. Similarly, if no one is home, the lights could be turned off and the heat or AC adjusted for power savings.

Further, distance to fixed peers within the network could be used to establish virtual boundaries, such that a robotic machine (e.g., a robotic vacuum) could stay in its designated room or a dog collar could create an electric fence by approximating the distance to known wireless peers.

Additionally, proximity information could boost new social applications or gaming activities like tag, geo-caching/fox hunts, or capture the flag, where flag capture and jail breaks can be announced to players over the mesh network.

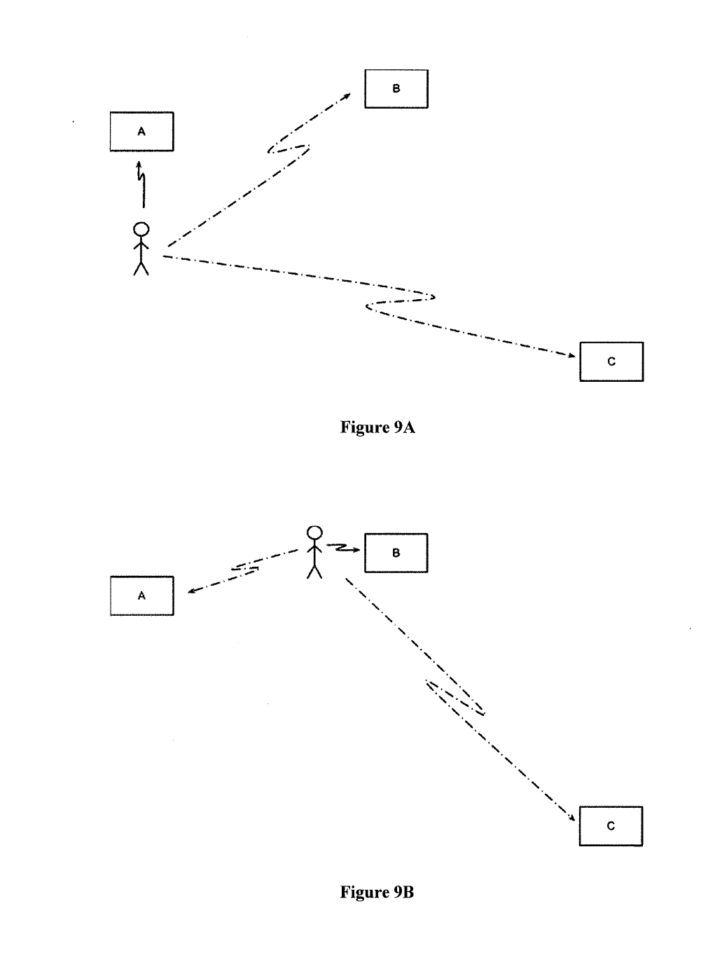

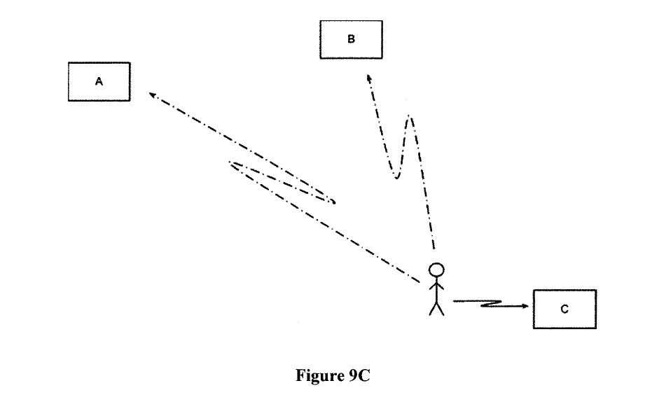

FIGS. 9A-9C illustrate a more detailed example in which device interaction could be chosen based on proximity. The user wants to play some content, like a movie. The application detects available peer devices to display the content. Referring to FIG. 9A, three peer devices, named A, B and C, capable of displaying the content are available. Based on proximity, as measured by signal strength, the content starts displaying on device A.

During the playback of the content, the user can move freely. Once the proximity to suitable peer devices changes, applications may decide to switch to another peer device. In FIG. 9B, display visualization switches from peer device A to peer device B as the proximity measurement changes to favor B.

Again, FIG. 9C illustrates a handoff based on the proximity measured from peer signal strength information, causing content playback to continue using peer device C.

### An Example of a Mobile Device

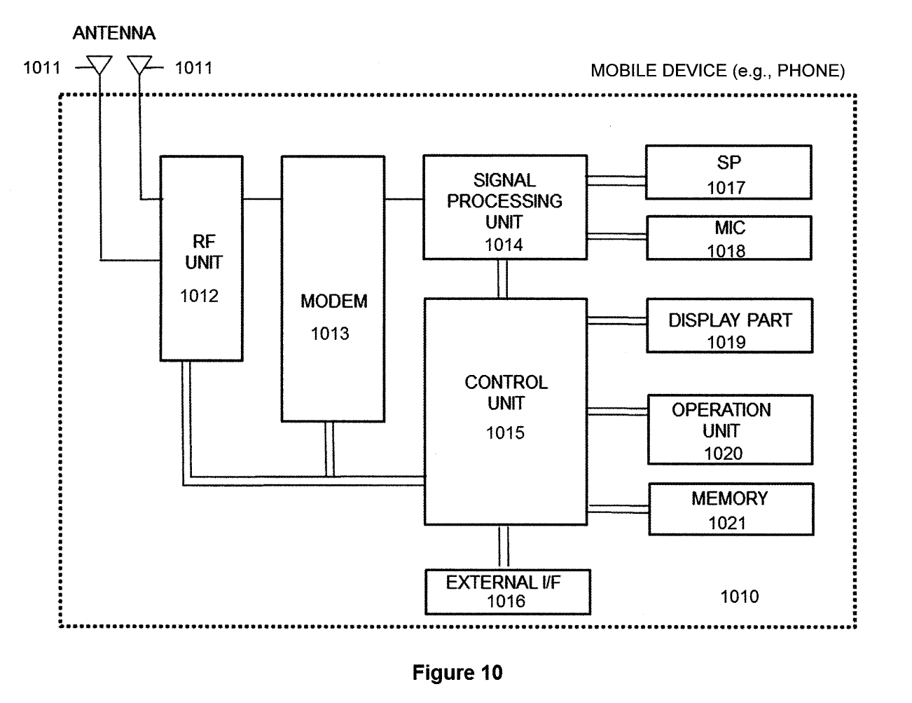

FIG. 10 is a block diagram of one embodiment of a mobile device (e.g., mobile phone) that includes a transmitter and/or the receiver. The mobile device may be part of a wireless mesh network that has multiple mobile devices operable to communicate directly with each other. In one embodiment, the mobile device comprises a wireless communication interface operable for connection via peer-to-peer communication to peer mobile devices in a wireless mesh network. In one embodiment, the mobile device also includes a memory and a processor coupled to the network interface and the memory. In one embodiment, the processor is operable to receive a broadcast communication (e.g., UDP packet) from a second peer in the wireless mesh network, measure the signal strength information corresponding to the received broadcast communication, and use the signal strength information to determine an estimate of distance between the mobile device and the peer that transmitted the broadcast packet.

Referring to FIG. 10, the mobile device 1010 includes an antenna 1011, a radio-frequency transceiver (an RF unit) 1012, a modem 1013, a signal processing unit 1014, a control unit 1015, an external interface unit (external I/F) 1016, a speaker (SP) 1017, a microphone (MIC) 1018, a display unit 1019, an operation unit 1020 and a memory 1021. In one embodiment, the external I/F 1016 includes an external interface (external I/F), a CPU (Central Processing Unit), a display unit, a keyboard, a memory, a hard disk and a CD-ROM drive. The CPU and the control unit 1015 in cooperation with the memories of mobile device 1010 (e.g., memory 1021, memory, and hard disk of the external I/F 1016) cooperate to perform the operations described above. Note that the transmitter and/or receiver may be included in other wireless devices (e.g., a wireless LAN).

In one embodiment, the memories of mobile device 1010 (e.g., memory 1021, memory, and hard disk of the external I/F 1016) store the code to gain access to the wireless or WiFi networks, including code to allow the mobile device to create, join, leave and rejoin a wireless mesh network, code for advertising itself and its content in the network, and code for exchanging messages and content with other devices and systems (e.g., servers) in these networks, and code for performing other operations described herein.

In one embodiment, the external I/F can be connected to a notebook, laptop, desktop or other computer. This can enable the user terminal to act as a wireless modem for the computer. The user terminal can be the computer's connection to the Internet, WiFi and WiMAX, a local area network, a wide area network, a personal area network, Bluetooth.

Code to implement the mobile device operations described herein can be stored in memory of the mobile device.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method for use by a first device of a plurality of devices in a wireless mesh network in which the plurality of devices communicate via peer-to-peer communication, the method comprising:
receiving a broadcast communication from a second device of the plurality of devices;
measuring signal strength information corresponding to received broadcast communication; and
using the signal strength information to determine an estimate of distance between the first device and the second device.

2. The method defined in claim 1 wherein using the signal strength information further comprises determining relative locations and other devices of the plurality of devices including the second device with respect to the first device based on the signal strength information.

3. The method defined in claim 1 further comprising generating, based on the signal strength information, a distance value representing a distance between the first and second devices.

4. The method defined in claim 1 wherein the received traffic comprises a 802.11s beacon.

5. The method defined in claim 1 further comprising generating, based on the signal strength information, a notification on the first device to notify a user of the first device regarding a distance between the first and second devices.

6. The method defined in claim 5 wherein the notification indicates that the second device is at a distance from the first device that has exceeded a distance threshold.

7. The method defined in claim 5 wherein the notification comprises a list of a set devices in the plurality of devices ordered based on their relative location between each other.

8. The method defined in claim 7 wherein the list is a sorted list of the set of devices ordered, based on their signal strength information as measured by the first device, according to their proximity to the first device.

9. The method defined in claim 1 further comprising:
recording, by an operating system running on the first device, the signal strength information and a MAC address associated with the second device;
requesting, by middleware software running on the first device, the signal strength information from the operating system;
determining, by the middleware software, whether a change has occurred in the signal strength information based on a comparison between the signal strength information and a previously recorded value stored by the middleware software.

10. The method defined in claim 9 further comprising sending a notification to an application on the first device if the change has occurred.

11. The method defined in claim 10 further comprising displaying the notification by the application.

12. The method defined in claim 9 further comprising performing a MAC address lookup based upon the IP address in the broadcast communication to determine the MAC address associated with the second device that sent the broadcast communication.

13. A computer-readable non-transitory storage medium having instructions stored therein which, when executed by a peer device, causes the peer device to perform a method comprising:
receiving a broadcast communication from a second device of a plurality of devices in a wireless mesh network in which the plurality of devices communicate via peer-to-peer communication;
measuring signal strength information corresponding to the received broadcast communication; and
using the signal strength information to determine an estimate of distance between the first device and the second device.

14. The storage medium defined in claim 13 wherein using the signal strength information further comprises determining relative locations and other devices of the plurality of devices including the second device with respect to the first device based on the signal strength information.

15. The storage medium defined in claim 13 wherein the method further comprises generating, based on the signal strength information, a distance value representing a distance between the first and second devices.

16. The storage medium defined in claim 13 wherein the received traffic comprises a 802.11s beacon.

17. The storage medium defined in claim 13 wherein the method further comprises generating, based on the signal strength information, a notification on the first device to notify a user of the first device regarding a distance between the first and second devices.

18. The storage medium defined in claim 17 wherein the notification indicates that the second device is at a distance from the first device that has exceeded a distance threshold.

19. The storage medium defined in claim 17 wherein the notification comprises a list of a set devices in the plurality of devices ordered based on their relative location between each other.

20. The storage medium defined in claim 19 wherein the list is a sorted list of the set of devices ordered, based on their signal strength information as measured by the first device, according to their proximity to the first device.

21. The storage medium defined in claim 13 wherein the method further comprises:
recording, by an operating system running on the first device, the signal strength information and a MAC address associated with the second device;
requesting, by middleware software running on the first device, the signal strength information from the operating system;
determining, by the middleware software, whether a change has occurred in the signal strength information based on a comparison between the signal strength information and a previously recorded value stored by the middleware software.

22. The storage medium defined in claim 21 wherein the method further comprises sending a notification to an application on the first device if the change has occurred.

23. The storage medium defined in claim 22 wherein the method further comprises displaying the notification by the application.

24. The storage medium defined in claim 21 wherein the method further comprises performing a MAC address lookup based upon the IP address in the broadcast communication to determine the MAC address associated with the second device that sent the broadcast communication.

25. A mobile device for use in a wireless mesh network having a plurality of mobile devices operable to communicate directly with each other via peer-to-peer communication, the mobile device comprising:
a wireless communication interface operable for wireless transmission to mobile devices in the wireless mesh network;
a memory;
a processor, coupled to the network interface and the memory, operable to:
receive a broadcast communication from a second device of the plurality of mobile devices;
measure signal strength information corresponding to the received broadcast communication; and
use the signal strength information to determine an estimate of distance between the first device and the second device.

26. A method for use by a first device of a plurality of devices in a wireless ad-hoc network in which the plurality of devices communicate via peer-to-peer communication, the method comprising:
receiving a broadcast communication from a second device of the plurality of devices;
measuring signal strength information corresponding to received broadcast communication; and
using the signal strength information to determine an estimate of distance between the first device and the second device.

27. The method defined in claim 26 further comprising:
recording, by an operating system running on the first device, the signal strength information and a MAC address associated with the second device;
requesting, by middleware software running on the first device, the signal strength information from the operating system;
determining, by the middleware software, whether a change has occurred in the signal strength information based on a comparison between the signal strength information and a previously recorded value stored by the middleware software; and
sending a notification to an application on the first device if the change has occurred.
